(19) United States
(12) Patent Application Publication
(10) Pub. No.: US 2026/0204477 A1
(43) Pub. Date: Jul. 16, 2026

(54) MULTILAYER ELECTRONIC COMPONENT

(71) Applicant: SAMSUNG ELECTRO-MECHANICS CO., LTD., Suwon-si (KR)

(72) Inventors: Sung Been Im, Suwon-si, Gyeonggi-do (KR); Dae Hee Lee, Suwon-si, Gyeonggi-do (KR)

(73) Assignee: SAMSUNG ELECTRO-MECHANICS CO., LTD., Suwon-si (KR)

(21) Appl. No.: 19/395,929

(22) Filed: Nov. 20, 2025

(30) Foreign Application Priority Data
Jan. 15, 2025 (KR) 10-2025-0005963

(51) Int. Cl. H01G 4/005; H01G 4/232; H01G 4/248; H01G 4/30

(52) U.S. Cl. CPC H01G 4/005; H01G 4/232; H01G 4/248; H01G 4/30

(57) ABSTRACT

A multilayer electronic component includes a body including a dielectric layer and an internal electrode alternately disposed with the dielectric layer, the body having first and second surfaces opposing each other in a first direction, the third and fourth surfaces opposing each other in a second direction, and fifth and sixth surfaces opposing each other in a third direction, and an external electrode disposed on the third and fourth surfaces. The internal electrode includes a plurality of conductive portions and a disconnected portion disposed between adjacent conductive portions. When an average value of electrode connectivity is ec, an average thickness of the dielectric layer is td, an average thickness of the internal electrode is te, sizes in the first and third directions of the multilayer electronic component are T and W, respectively, te/(ec×td)≤0.800 and T/W≤0.714 are satisfied.

### CROSS-REFERENCE TO RELATED APPLICATION(S)

This application claims benefit of priority to Korean Patent Application No. 10-2025-0005963 filed on Jan. 15, 2025 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as image display devices, including a liquid crystal display (LCD) and a plasma display panel (PDP), computers, smartphones, and mobile phones, and serves to charge or discharge electricity therein or therefrom. The MLCC may be used as a component of various electronic devices due to having a small size, ensuring high capacitance and being easily mounted.

In general, an MLCC may have a form in which a width (W size) and a thickness (T size) are similar to each other. However, with the recent advancement of technologies such as 5G and foldable devices, miniaturization and thinning of MLCCs have been required, and accordingly, development of a low-profile MLCC having a specific form in which a thickness size is less than a width size has been conducted.

However, it has been found that a low-profile MLCC is more vulnerable to cracks (hereinafter, referred to as shrinkage cracks) caused by a difference in sintering shrinkage rates between a capacitance formation portion, in which a dielectric layer and an internal electrode are laminated, and a cover/margin portion, in which no internal electrode is laminated, than a general MLCC. When shrinkage cracks occur, external moisture may permeate into the low-profile MLCC, thereby reducing moisture resistance reliability of the low-profile MLCC.

### SUMMARY

An aspect of the present disclosure is to provide a multilayer electronic component having a small T size and excellent reliability.

However, the aspects of the present disclosure are not limited to those set forth herein, and will be more easily understood in the course of describing specific example embodiments of the present disclosure.

According to an aspect of the present disclosure, there is provided a multilayer electronic component including a body including a dielectric layer and internal electrodes alternately disposed with the dielectric layer in a first direction, the body having first and second surfaces opposing each other in the first direction, third and fourth surfaces connected to the first and second surfaces, the third and fourth surfaces opposing each other in a second direction, and fifth and sixth surfaces connected to the first to fourth surfaces, the fifth and sixth surfaces opposing each other in a third direction, and an external electrode disposed on the third surface and the fourth surface. The internal electrodes may include a plurality of conductive portions, and a disconnected portion disposed between adjacent conductive portions among the plurality of conductive portions. When an average value of electrode connectivity, a ratio of a sum of lengths of the plurality of conductive portions to an overall length of an internal electrode among the internal electrodes, is denoted by ec, an average thickness of the dielectric layer is denoted by td, an average thickness of the internal electrode is denoted by te, a size in the first direction of the multilayer electronic component is denoted by T, and a size in the third direction of the multilayer electronic component is denoted by W, te/(ec×td)≤0.800 and T/W≤0.714 may be satisfied.

According to example embodiments of the present disclosure, a multilayer electronic component may have a small T size and excellent reliability.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic exploded perspective view of a body and a side margin portion of the example embodiment illustrated in FIG. 1;

FIG. 3 is a schematic cross-sectional view taken along line I-I′ of FIG. 1;

FIG. 4 is a schematic cross-sectional view taken along line II-II′ of FIG. 1;

FIG. 5 is a schematic enlarged view of a central region of a capacitance formation portion;

FIG. 6 is a schematic enlarged view of region “K1” of FIG. 5; and

FIG. 7 is an image of a central region of a capacitance formation portion of a multilayer electronic component according to an example embodiment of the present disclosure, captured by a scanning electron microscope (SEM).

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by te same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, a first direction (D1) may be defined as a thickness direction, a second direction (D2) may be defined as a length direction, and a third direction (D3) may be defined as a width direction.

### Multilayer Electronic Component

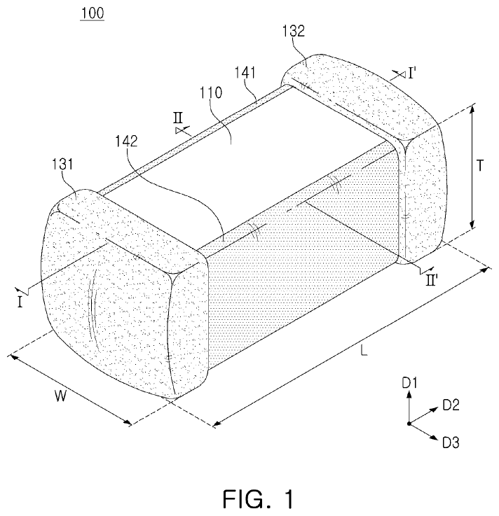

FIG. 1 is a schematic perspective view of a multilayer electronic component according to an example embodiment of the present disclosure.

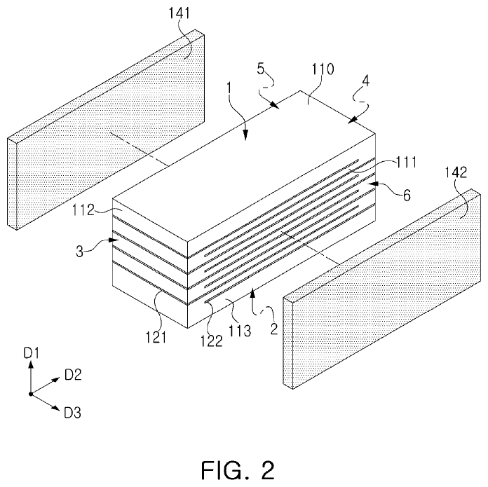

FIG. 2 is a schematic exploded perspective view of a body and a side margin portion of the example embodiment illustrated in FIG. 1.

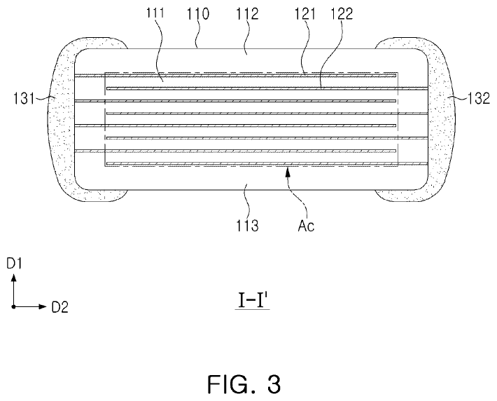

FIG. 3 is a schematic cross-sectional view taken along line I-I′ of FIG. 1.

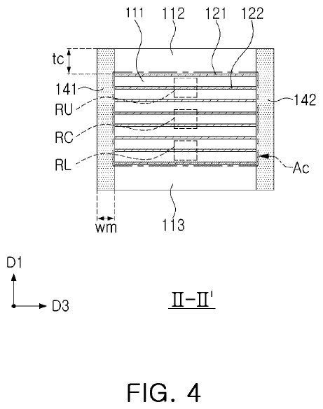

FIG. 4 is a schematic cross-sectional view taken along line II-II′ of FIG. 1.

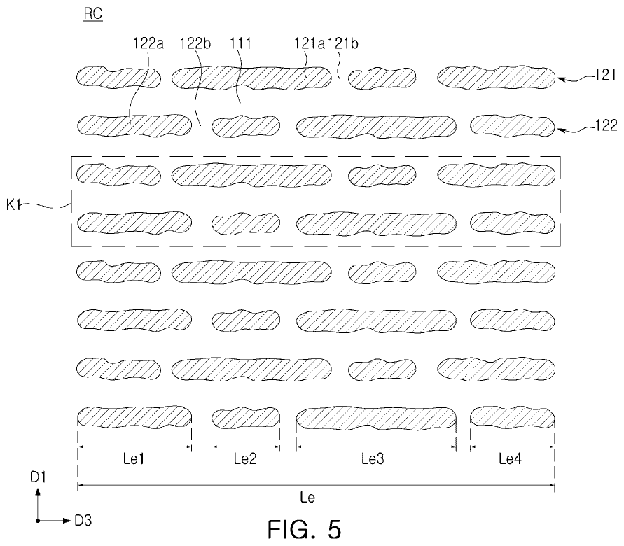

FIG. 5 is a schematic enlarged view of a central region of a capacitance formation portion.

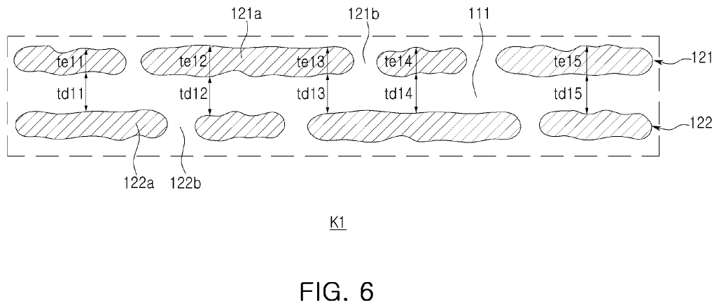

FIG. 6 is a schematic enlarged view of region “K1” of FIG. 5.

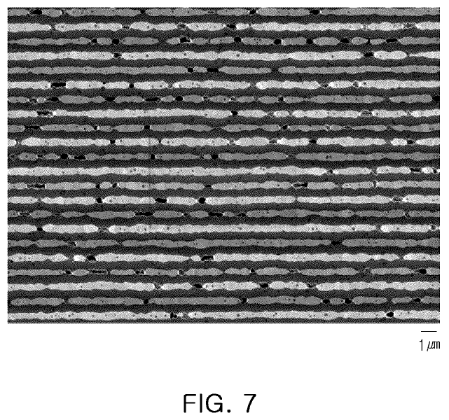

FIG. 7 is an image of a central region of a capacitance formation portion of a multilayer electronic component according to an example embodiment of the present disclosure, captured by a scanning electron microscope (SEM).

Hereinafter, a multilayer electronic component 100 according to an example embodiment of the present disclosure will be described in detail with reference to FIGS. 1 to 7. In addition, a multilayer ceramic capacitor (hereinafter referred to as “MLCC”) is described as an example of the multilayer electronic component, but the present disclosure is not limited thereto, and may be applied to various electronic products formed of a ceramic material, such as inductors, piezoelectric elements, varistors, thermistors, or the like.

A multilayer electronic component 100 according to an example embodiment of the present disclosure may include a body 110 and external electrodes 131 and 132.

A specific shape of the body 110 is not limited. However, as illustrated, the body 110 may have a hexahedral shape or a shape similar thereto. Due to shrinkage of ceramic powder included in the body 110 during a sintering process or polishing of corners, the body 110 may not have a hexahedral shape having perfectly straight lines, but may have a substantially hexahedral shape.

The body 110 may have first and second surfaces 1 and 2 opposing each other in the first direction, third and fourth surfaces 3 and 4 connected to the first and second surfaces 1 and 2, the third and fourth surfaces 3 and 4 opposing each other in the second direction, and fifth and sixth surfaces 5 and 6 connected to the first to fourth surfaces 1, 2, 3, and 4, the fifth and sixth surfaces 5 and 6 opposing each other in the third direction.

The body 110 may include a dielectric layer 111 and internal electrodes 121 and 122 alternately disposed with the dielectric layer 111 in the first direction. A plurality of dielectric layers 111, included in the body 110, may be in a sintered state, and adjacent dielectric layers 111 may be integrated with each other such that boundaries therebetween are not readily apparent without using an SEM.

The dielectric layer 111 may include, for example, a perovskite-type compound, represented by ABO₃, as a main ingredient. The perovskite-type compound, represented by ABO₃, may be, for example, one or more of BaTiO₃, (Ba₁₋ₓCaₓ)TiO₃ (0<x<1), Ba (Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5).

The internal electrodes 121 and 122 may include a first internal electrode 121 and a second internal electrode 122 alternately disposed in the first direction with the dielectric layer 111 interposed therebetween. The first internal electrode 121 and the second internal electrode 122 may be electrically isolated from each other by the dielectric layer 111 interposed therebetween.

The first internal electrode 121 may extend to the third, fifth, and sixth surfaces 3, 5, and 6, and may be spaced apart from the fourth surface 4. The second internal electrode 122 may extend to the fourth, fifth, and sixth surfaces 4, 5, and 6, and may be spaced apart from the third surface 3.

A conductive metal, included in the internal electrodes 121 and 122, may include one or more of Ni, Cu, Al, Pd, Ag, In, Sn, Ti, and alloys thereof, and may include, for example, Ni, but the present disclosure is not limited thereto.

The internal electrodes 121 and 122 may include a plurality of conductive portions 121a and 122a and disconnected portions 121b and 122b disposed between adjacent conductive portions 121a and 122a, respectively. That is, the first internal electrode 121 may include a plurality of first conductive portions 121a and a first disconnected portion 121b disposed between adjacent first conductive portions 121a, and the second internal electrode 122 may include a plurality of second conductive portions 122a and a second disconnected portion 122b disposed between adjacent second conductive portions 122a.

The conductive portions 121a and 122a may refer to regions in which a conductive metal is disposed, and the disconnected portions 121b and 122b may refer to regions in which a conductive metal is not disposed. Due to a difference in sintering shrinkage initiation temperature between the dielectric layer 111 and the internal electrodes 121 and 122, a mismatch in shrinkage behavior may occur between the dielectric layer 111 and the internal electrodes 121 and 122. In this case, a conductive metal of the internal electrodes 121 and 122 may locally agglomerate to form voids, and such voids may form the disconnected portions 121b and 122b by sintering.

The body 110 may include a capacitance formation portion Ac disposed in the body 110, the capacitance formation portion Ac in which the dielectric layer 111 and the internal electrodes 121 and 122 are alternately disposed with the dielectric layer 111 to form capacitance, and first and second cover portions 112 and 113 respectively disposed on both surfaces of the capacitance formation portion Ac, opposing each other in the first direction.

The multilayer electronic component 100 may include side margin portions 141 and 142 disposed on the fifth and sixth surfaces 5 and 6. The multilayer electronic component 100 may include a first side margin portion 141 disposed on the fifth surface 5 and a second side margin portion 142 disposed on the sixth surface 6. The side margin portions 141 and 142 may be disposed to cover end portions of the internal electrodes 121 and 122 extending to the fifth and sixth surfaces 5 and 6.

The cover portions 112 and 113 and the side margin portions 141 and 142 may include a perovskite-type compound, represented by ABO₃, as a main ingredient. The cover portions 112 and 113 and the side margin portions 141 and 142 may have a dielectric composition different from that of the dielectric layer 111, but the present disclosure is not limited thereto.

The external electrodes 131 and 132 may be disposed on the third and fourth surfaces 3 and 4. The external electrodes 131 and 132 may include a first external electrode 131 disposed on the third surface 3 and connected to the first internal electrode 121, the first external electrode 131 extending onto portions of the first, second, fifth, and sixth surfaces 1, 2, 5, and 6, and a second external electrode 132 disposed on the fourth surface 4 and connected to the second internal electrode 122, the second external electrode 132 extending onto portions of the first, second, fifth, and sixth surfaces 1, 2, 5, and 6.

A type or form of the external electrodes 131 and 132 is not limited, and may have a multilayer structure. For example, the external electrodes 131 and 132 may include a base electrode layer in contact with the internal electrodes 121 and 122, and a plating layer disposed on the base electrode layer.

The base electrode layer may be a sintered electrode layer including a metal and glass. The metal, included in the sintered electrode layer, may include, for example, Cu, Ni, Pd, Pt, Au, Ag, Pb, and/or an alloy including the same. The glass, included in the sintered electrode layer, may include, for example, one or more oxides of Ba, Ca, Zn, Al, B, and Si.

The base electrode layer may include only the sintered electrode layer including a metal and glass, but the present disclosure is not limited thereto. The base electrode layer may include, for example, a sintered electrode layer including a metal and glass, and a resin electrode layer disposed on the sintered electrode layer, the resin electrode layer including metal particles and resin.

The metal particles, included in the resin electrode layer, may include one or more of spherical particles and flake-type particles. The metal particles, included in the resin electrode layer, may include, for example, Cu, Ni, Pd, Ag, Pb, Sn and/or an alloy including the same. The resin, included in the resin electrode layer, may include, for example, one or more of epoxy resin, acrylic resin, and ethyl cellulose.

The plating layer may include, for example, Ni, Sn, Pd, and/or an alloy including the same, and may be formed of a plurality of layers. The plating layer may be, for example, a Ni plating layer or a Sn plating layer, and may also be formed in a structure in which a Ni plating layer and a Sn plating layer are sequentially formed. The plating layer may include a plurality of Ni plating layers and/or a plurality of Sn plating layers.

In the drawings, a structure is described in which the multilayer electronic component 100 has two external electrodes 131 and 132, but the present disclosure is not limited thereto, and the number or shape of the external electrodes 131 and 132 may be changed depending on the form of the internal electrodes 121 and 122 or other purposes.

According to an example embodiment of the present disclosure, when a size in the first direction of the multilayer electronic component 100 is denoted by T and a size in the third direction of the multilayer electronic component 100 is denoted by W, T<W may be satisfied. More preferably, the multilayer electronic component 100 may satisfy T/W≤0.714. Accordingly, a size in the first direction (T) of the multilayer electronic component 100 may be reduced, thereby enabling miniaturization of the multilayer electronic component 100. A lower limit of T/W is not limited, and may vary depending on specifications of the multilayer electronic component 100 required by a user. In an example embodiment, considering a capacitance or the like of the multilayer electronic component 100, T/W may be 0.400 or more.

When a ratio of T to W (T/W) is lowered to 0.714 or less to miniaturize the multilayer electronic component 100, it may be confirmed that a sintering shrinkage rate difference between the capacitance formation portion Ac and the cover portions 112 and 113 and the side margin portions 141 and 142 increases, resulting in a large number of shrinkage cracks. Accordingly, when the multilayer electronic component 100 is designed to satisfy T/W≤0.714 for miniaturization, additional design measures to prevent shrinkage cracks may be necessary.

Accordingly, according to an example embodiment of the present disclosure, when an average value of electrode connectivity, a ratio of a sum of lengths of the plurality of conductive portions 121a and 122a to an overall length of each of the internal electrodes 121 and 122 is denoted by ec, an average thickness of the dielectric layer 111 is denoted by td, and an average thickness of each of the internal electrodes 121 and 122 is denoted by te, te/(ec×td)≤0.800 may be satisfied. When te/(ec×td)≤0.800 is satisfied, a sintering shrinkage rate difference between the capacitance formation portion Ac and the cover portions 112 and 113 and the side margin portions 141 and 142 may be reduced, thereby suppressing the occurrence of shrinkage cracks.

A lower limit of te/(ec×td) is not limited. This may be because that ec also tends to decrease as the decreases. However, when the decreases below a certain level relative to td, ec may rapidly decrease. In this case, shrinkage cracks may be suppressed. However, the capacitance of the multilayer electronic component 100 may decrease, or a short-circuit defect rate may increase. Accordingly, in an example embodiment, te/(ec×td) may be greater than 0.758.

When te/(ec×td)≤0.800 is satisfied, a range of each of ec, td, and te is not limited, and may vary according to specifications and electrical characteristics of the multilayer electronic component 100 required by a user. For example, the multilayer electronic component 100 according to an example embodiment may satisfy 0.30 mm≤W≤0.75 mm and 0.80 mm≤L≤1.25 mm. Here, L may denote a size in the second direction of the multilayer electronic component 100. That is, the multilayer electronic component 100 may have a size of 1005 (L: about 1.0 mm, W: about 0.5 mm) or less. For example, the multilayer electronic component 100 may satisfy 0.45 mm≤W≤0.70 mm, 0.85 mm≤L≤1.15 mm, and/or T/W≤0.714, and have a capacitance of 4 μF or more and 22 μF or less. T, L, and W may be measured using an optical microscope, and the capacitance may be measured with a multimeter. Other methods and/or tools appreciated by one of ordinary skill in the art, even if not described in the present disclosure, may also be used.

ec is not limited. However, considering the capacitance of the multilayer electronic component 100, ec may satisfy 0.924≤ec. An upper limit of ec is not limited and may, for example, be less than 1.0.

td and the are not limited. However, considering high capacitance and reliability of the multilayer electronic component 100, td and the may satisfy 450 nm≤td≤600 nm and/or 370 nm≤te≤550 nm.

Hereinafter, with reference to FIGS. 4 to 6, an example of a method of measuring ec, td, and te will be described.

ec may be measured using the following method. First, a cross-section of the multilayer electronic component 100 in the first and third directions, obtained by polishing the multilayer electronic component 100 up to a central portion in the second direction of the multilayer electronic component 100, may be exposed. Then, a first image may be obtained by magnifying, using the SEM, a central region in the first direction RC of the capacitance formation portion Ac. As illustrated in FIG. 5, a plurality of internal electrodes 121 and 122 may be observed in the first image. Other methods and/or tools appreciated by one of ordinary skill in the art, even if not described in the present disclosure, may also be used.

A value of electrode connectivity of each of the internal electrodes 121 and 122 may be defined as a ratio (Le1+Le2+Le3+Le4/Le) of a sum of lengths of the plurality of conductive portions 121a and 122a to an overall length of each of the internal electrodes 121 and 122. Assuming that the number of all internal electrodes 121 and 122, present in the first image, is n, values of electrode connectivity (En) of n internal electrodes 121 and 122 may be measured, respectively, and then an average (E1+E2+ . . . +En/n) of the electrode connectivity values (En) may be calculated. The average (E1+E2+ . . . +En/n) may be defined as an average value of electrode connectivity (ec1) measured in the central region RC of the capacitance formation portion Ac.

Subsequently, a second image may be obtained by magnifying, using the SEM, an upper region (e.g., first region) RU of the capacitance formation portion Ac adjacent to the first cover portion 112. Values of electrode connectivity of all internal electrodes 121 and 122, present in the second image, may be measured, respectively, and then an average of the electrode connectivity values may be calculated. The average may be defined as an average value of electrode connectivity (ec2) measured in the upper region RU.

Similarly, a third image may be obtained by magnifying, using the SEM, a lower region (e.g., second region) RL of the capacitance formation portion Ac adjacent to the second cover portion 113. Values of electrode connectivity of all internal electrodes 121 and 122, present in the third image, may be measured, respectively, and then an average of the electrode connectivity values may be calculated. The average may be defined as an average value of electrode connectivity (ec3) measured in the lower region RL.

Magnification of the SEM may be, for example, 50,000 times or more, but the present disclosure is not limited thereto. In each of the first to third images, 10 or more internal electrodes 121 and 122 may be observed.

ec may be defined as an average value between ec1, ec2, and ec3. That is, when the average value of electrode connectivity measured in the central region in the first direction RC of the capacitance formation portion Ac is denoted by ec1, the average value of electrode connectivity measured in the upper region RU of the capacitance formation portion Ac adjacent to the first cover portion 112 is denoted by ec2, and the average value of electrode connectivity measured in the lower region RL of the capacitance formation portion Ac adjacent to the second cover portion 113 is denoted by ec3, ec may be (ec1+ec2+ec3)/3.

td and the may be measured using the following method.

Thicknesses of a single internal electrode 121 or 122, present in the first image, may be measured at multiple points, for example, at five or more arbitrary points (te11, te12, te13, te14, te15, . . . ) of the internal electrode 121 or 122, and then an average of the thicknesses may be calculated to measure an average thickness of the internal electrode 121 or 122 positioned in the central region RC. The five or more points may be designated in the plurality of conductive portions 121a and 122a. Other methods and/or tools appreciated by one of ordinary skill in the art, even if not described in the present disclosure, may also be used.

Assuming that the number of all internal electrodes 121 and 122, present in the first image, is n, average thicknesses (TEn) of n internal electrodes 121 and 122 may be measured, respectively, and then an average (TE1+TE2+ . . . +TEn/n) of the average thicknesses (TEn) may be calculated. The average (TE1+TE2+ . . . +TEn/n) may be defined as an average thickness (te1) of the internal electrodes 121 and 122 measured in the central region RC.

Subsequently, average thicknesses of all internal electrodes 121 and 122, present in the second image, may be measured, respectively, and then an average of the average thicknesses may be calculated. The average may be defined as an average thickness (te2) of the internal electrodes 121 and 122 measured in the upper region RU.

Similarly, average thicknesses of all internal electrodes 121 and 122, present in the third image, may be measured, respectively, and then an average of the average thicknesses may be calculated. The average may be defined as an average thickness (te3) of the internal electrodes 121 and 122 measured in the lower region RL.

the may be defined as an average value between te1, te2, and te3. That is, when an average thickness of the internal electrodes 121 and 122 measured in the central region RC is denoted by te1, an average thickness of the internal electrodes 121 and 122 measured in the upper region RU is denoted by te2, and an average thickness of the internal electrodes 121 and 122 measured in the lower region RL is denoted by te3, the may be (te1+te2+te3)/3.

Similarly, thicknesses of a single dielectric layer 111, present in the first image, may be measured at multiple points, for example, at five or more arbitrary points (td11, td12, td13, td14, td15, . . . ) of the dielectric layer 111, and then an average of the thicknesses may be calculated to measure an average thickness of the dielectric layer 111 positioned in the central region RC. The five or more points may be designated between a first conductive portion 121a and a second conductive portion 122a, and may be designated on the same line as the five or more points used for measuring the thicknesses (te11, te12, te13, te14, te15, . . . ) of the internal electrodes 121 and 122, but the present disclosure is not limited thereto. Other methods and/or tools appreciated by one of ordinary skill in the art, even if not described in the present disclosure, may also be used.

When the number of all dielectric layers 111, present in the first image, is n, average thicknesses (TDn) of n dielectric layers 111 may be measured, respectively, and then an average (TD1+TD2+ . . . +TDn/n) of the average thicknesses (TDn) may be calculated. The average (TD1+TD2+ . . . +TDn/n) may be defined as an average thickness (td1) of the dielectric layer 111 measured in the central region RC of the capacitance formation portion Ac.

Subsequently, average thicknesses of all dielectric layers 111, present in the second image, may be measured, respectively, and then an average of the average thicknesses may be calculated. The average may be defined as an average thickness (td2) of the dielectric layer 111 measured in the upper region RU.

Similarly, average thicknesses of all dielectric layers 111, present in the third image, may be measured, respectively, and then an average of the average thicknesses may be calculated. The average may be defined as an average thickness (td3) of the dielectric layer 111 measured in the lower region RL.

td may be defined as an average value between td1, td2, and td3. That is, when the average thickness of the dielectric layer 111 measured in the central region RC is denoted by td1, the average thickness of the dielectric layer 111 measured in the upper region RU is denoted by td2, and the average thickness of the dielectric layer 111 measured in the lower region RL is denoted by td3, td may be (td1+td2+td3)/3.

ec, td, and te may be values measured by automatically analyzing the first to third images using an image analysis program, or may be values measured by manually analyzing the first to third images.

An average thickness (tc) of each of the cover portions 112 and 113 is not limited. For example, the average thickness (tc) of each of the cover portions 112 and 113 may be 10 μm or more and 40 μm or less. Here, the average thickness (tc) of each of the cover portions 112 and 113 may refer to an average thickness of each of the first cover portion 112 and the second cover portion 113. The average thickness (tc) of each of the cover portions 112 and 113 may be a value obtained by averaging thicknesses of each of the cover portions 112 and 113 in the first direction, measured at five points spaced apart from each other at equal intervals, in a cross-section in in the first and third directions of the multilayer electronic component 100.

An average thickness (wm) of each of the side margin portions 141 and 142 is not limited. For example, the average thickness (wm) of each of the side margin portions 141 and 142 may be 5 μm or more and 30 μm or less. Here, the average thickness (wm) of each of the side margin portions 141 and 142 may refer to an average thickness of each of the first side margin portion 141 and the second side margin portion 142. The average thickness (wm) of each of the side margin portions 141 and 142 may be a value obtained by averaging thicknesses in the third direction of each of the side margin portions 141 and 142, measured at five points spaced apart from each other at equal intervals, in a cross-section in the first and third directions of the multilayer electronic component 100.

Hereinafter, an example of a method of forming the multilayer electronic component 100 will be described. However, a method of manufacturing the multilayer electronic component 100 is not limited thereto.

First, ceramic powder particles for forming the dielectric layer 111 may be prepared. The ceramic powder particles may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5). BaTiO₃ powder particles may be synthesized, for example, by reacting a titanium raw material such as titanium dioxide and a barium raw material such as barium carbonate. A synthesis method of the ceramic powder particles may include, for example, a solid-state method, a sol-gel method, or a hydrothermal synthesis method, but the present disclosure is not limited thereto. Subsequently, the prepared ceramic powder particles may be dried and pulverized, and then mixed with an organic solvent such as ethanol, a binder such as polyvinyl butyral, and other sub-ingredients to prepare a ceramic slurry. Thereafter, the ceramic slurry may be coated and dried on a carrier film to prepare a sheet for dielectric layer formation.

Subsequently, an internal electrode conductive paste, including metal powder particles, a binder, and an organic solvent, may be printed on the sheet for dielectric layer formation to a predetermined thickness using a screen-printing method or a gravure-printing method, thereby forming an internal electrode pattern.

Thereafter, the sheet for dielectric layer formation having the internal electrode pattern printed thereon may be peeled off from the carrier film, and a predetermined number of sheets for dielectric layer formation may be laminated and pressed to form a ceramic laminate. In order to form cover portions 112 and 113 after sintering, a predetermined number of sheets for dielectric layer formation in which no internal electrode pattern is formed may be laminated on an upper portion and a lower portion of the ceramic laminate. Thereafter, the ceramic laminate may be cut to have a predetermined chip size. In this case, an end portion of the internal electrode pattern may be exposed to both surfaces of the cut chip, opposing each other in the third direction.

Subsequently, a sheet for side margin portion formation may be attached to both surfaces in the third direction of the cut chip, and then sintering may be performed to form a body 110 and side margin portions 141 and 142. Sintering may be performed, for example, under an H₂O/H₂/N₂ atmosphere in 1.0% H₂/99.0% N₂ to 3.5% H₂/96.5% N₂ at a temperature of 1000° C. or higher and 1400° C. or lower for 1 hour to 3 hours.

ec, td, and te may be controlled by adjusting a diameter of a metal powder particle included in the internal electrode conductive paste, a diameter of a ceramic powder particle included in the sheet for dielectric layer formation, a thickness of the internal electrode pattern, a thickness of the sheet for dielectric layer formation, and a sintering condition.

Subsequently, external electrodes 131 and 132 may be formed. For example, when a base electrode layer includes a sintered electrode layer, the body 110 to which the side margin portions 141 and 142 are attached may be dipped into an external electrode conductive paste including metal powder particles, glass frit, a binder, and an organic solvent, and the external electrode conductive paste may be sintered at a temperature of 500° C. to 900° C. to form the sintered electrode layer.

For example, when the base electrode layer includes a resin electrode layer, the body 110 to which the side margin portions 141 and 142 are attached may be dipped into a conductive resin composition including metal powder particles, resin, a binder, and an organic solvent, and cured by heat treatment at a temperature of 250° C. to 550° C. to form the resin electrode layer.

In addition, a plating layer may be formed on the base electrode layer by additionally performing an electrolytic plating method and/or an electroless plating method.

### Experimental Examples

Example embodiments will be described in more detail below with reference to experimental examples. However, the present disclosure is not limited to the experimental examples, which are provided only to facilitate a specific understanding of the present disclosure.

Through the above-described manufacturing method, a sample chip having a size of 1005 (L: about 0.80 mm to about 1.25 mm, W: about 0.30 mm to about 0.75 mm) was prepared. A size in a first direction (T) and a size in a third direction (W) of the sample chip were measured and are indicated in Table 1 below.

Subsequently, a cross-section in the first and third directions of the sample chip, obtained by polishing the sample chip up to a central portion in a second direction of the sample chip, was exposed, and then a central region in the first direction of a capacitance formation portion was magnified 50,000 times using an SEM to obtain the first image illustrated in FIG. 7. In FIG. 7, a relatively bright region of an internal electrode may be a conductive portion, and a relatively dark region of the internal electrode, caused by voids, may be a disconnected portion. A region disposed between internal electrodes may be a dielectric layer.

Values of electrode connectivity (a sum of lengths of a plurality of conductive portions relative to an overall length of the internal electrode) of all internal electrodes, present in the first image, were measured, respectively, and an average value (ec1) of the electrode connectivity was obtained.

Subsequently, average thicknesses of all the internal electrodes, present in the first image, were measured. Specifically, an average thickness of a single internal electrode was obtained by measuring thicknesses of the internal electrode at five arbitrary points of the internal electrode and then calculating an average of the thicknesses. The five points were designated in the conductive portion. Thereafter, the average thicknesses of all the internal electrodes, present in the first image, were measured, and then an average value (te1) of the average thicknesses was obtained.

Thereafter, an average thickness of a dielectric layer, present in the first image, was measured. Specifically, an average thickness of a single dielectric layer was measured by measuring thicknesses of the dielectric layer at five arbitrary points of the dielectric layer and then calculating an average value of the thicknesses. The five points were designated between a first conductive portion and a second conductive portion. Thereafter, average thicknesses of all dielectric layers, present in the first image, were measured, and then an average value (td1) of the average thicknesses was obtained.

In the same manner, a second image was obtained by magnifying, using the SEM, an upper region of the capacitance formation portion adjacent to a first cover portion. Thereafter, values of electrode connectivity of all internal electrodes, present in the second image, were measured, respectively, and an average value (ec2) of the electrode connectivity was obtained. Average thicknesses of all the internal electrodes, present in the second image, were measured, respectively, and an average value (te2) of the average thicknesses was obtained. Average thicknesses of all dielectric layers, present in the second image, were measured, and an average value (td2) of the average thicknesses was obtained.

Similarly, a third image may be obtained by magnifying, using the SEM, a lower region of the capacitance formation portion adjacent to a second cover portion. Thereafter, values of electrode connectivity of all internal electrodes, present in the third image, were measured, respectively, and an average value (ec3) of the electrode connectivity was obtained. Average thicknesses of all the internal electrodes, present in the third image, were measured, respectively, and an average value (te3) of the average thicknesses was obtained. Average thicknesses of all dielectric layers, present in the third image, were measured, respectively, and an average value (td3) of the average thicknesses was obtained.

Finally, an average value of electrode connectivity (ec) was calculated as (ec1+ec2+ec3)/3, an average thickness (the) of the internal electrode was calculated as (te1+te2+te3)/3, and an average thickness (td) of the dielectric layer was calculated as (td1+td2+td3)/3, and are indicated in Table 1 below.

TABLE 1

| Sample | | | | | |
|---|---|---|---|---|---|
| Number | ec | te(nm) | td(nm) | T(mm) | W(mm) |
| 1 | 0.782 | 332 | 560 | 0.355 | 0.632 |
| 2 | 0.958 | 422 | 558 | 0.341 | 0.65 |
| 3 | 0.924 | 429 | 583 | 0.34 | 0.652 |
| 4 | 0.963 | 442 | 575 | 0.338 | 0.641 |
| 5 | 0.949 | 439 | 536 | 0.343 | 0.652 |
| 6 | 0.948 | 441 | 523 | 0.342 | 0.663 |
| 7 | 0.895 | 428 | 520 | 0.337 | 0.641 |
| 8 | 0.970 | 499 | 538 | 0.332 | 0.655 |
| 9 | 0.912 | 449 | 549 | 0.461 | 0.611 |
| 10 | 0.871 | 426 | 531 | 0.458 | 0.612 |
| 11 | 0.887 | 468 | 493 | 0.451 | 0.62 |

Based on the values in Table 1, te/(ec×td) and T/W were calculated, and calculation results are indicated in Table 2 below. Subsequently, for each sample number, 300 to 1000 sample chips were prepared, and a shrinkage crack defect rate and a short-circuit defect rate were measured. Finally, characteristics of each sample number were evaluated as poor (x), good (Δ), or excellent (∘).

TABLE 2

| | | | Crack | Short-circuit | |
|---|---|---|---|---|---|
| Sample | te/ | | defect | defect | |
| Number | (ec × td) | T/W | rate (ppm) | rate (%) | Evaluation |
| 1 | 0.758 | 0.562 | 0 | 76.7% | Δ |
| 2 | 0.789 | 0.525 | 0 | 11.2% | ∘ |
| 3 | 0.796 | 0.521 | 0 | 7.3% | ∘ |
| 4 | 0.798 | 0.527 | 0 | 4.5% | ∘ |
| 5 | 0.863 | 0.526 | 367 | 6.7% | x |
| 6 | 0.890 | 0.516 | 2133 | 6.7% | x |
| 7 | 0.920 | 0.526 | 500 | 26.1% | x |
| 8 | 0.956 | 0.507 | 500 | 8.7% | x |
| 9 | 0.897 | 0.755 | 0 | 20.0% | x |
| 10 | 0.921 | 0.748 | 0 | 23.0% | x |
| 11 | 1.070 | 0.727 | 0 | 17.4% | x |

For sample numbers 5 to 8, T/W≤0.714 was satisfied, but te/(ec×td) was greater than 0.800. Accordingly, a large number of shrinkage cracks were observed.

For sample numbers 9 and 10, T/W was greater than 0.714 and te/(ec×td) was greater than 0.800. Accordingly, shrinkage cracks due to miniaturization did not occur, but a short-circuit defect rate slightly increased.

For sample numbers 1 to 4, T/W≤0.714 and te/(ec×td)≤0.800 were satisfied, such that miniaturization of a multilayer electronic component was achieved while the occurrence of shrinkage cracks was suppressed. However, for sample number 1, te/(ec×td) was 0.758 or less, an increase in short-circuit defect rate was confirmed. It may be expected that this is because a thickness of the internal electrode is excessively reduced relative to a thickness of the dielectric layer.

While example embodiments have been illustrated and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

As used herein, the term “connected” may not only refer to “directly connected” but also “indirectly connected” by means of an adhesive layer or the like. The term “electrically connected” may include both a case in which elements are “physically connected” and a case in which elements are “not physically connected.” In addition, the terms “first,” “second,” and the like may be used to distinguish an element from another element, and may not imply any particular order and/or importance, or others in relation to the elements. In some cases, a first element may be referred to as a second element, and similarly, a second element may be referred to as a first element without departing from the scope of the example embodiments.

What is claimed is:

1. A multilayer electronic component comprising:
a body including a dielectric layer and internal electrodes alternately disposed with the dielectric layer in a first direction, the body having first and second surfaces opposing each other in the first direction, third and fourth surfaces connected to the first and second surfaces, the third and fourth surfaces opposing each other in a second direction, and fifth and sixth surfaces connected to the first to fourth surfaces, the fifth and sixth surfaces opposing each other in a third direction, and
an external electrode disposed on the third surface and the fourth surface,
wherein the internal electrodes include a plurality of conductive portions, and a disconnected portion disposed between adjacent conductive portions among the plurality of conductive portions, and
when an average value of electrode connectivity, a ratio of a sum of lengths of the plurality of conductive portions to an overall length of an internal electrode among the internal electrodes, is denoted by ec, an average thickness of the dielectric layer is denoted by td, an average thickness of the internal electrode is denoted by te, a size in the first direction of the multilayer electronic component is denoted by T, and a size in the third direction of the multilayer electronic component is denoted by W, te/(ec×td)≤0.800 and T/W≤0.714 are satisfied.

2. The multilayer electronic component of claim 1, wherein 0.758<te/(ec×td) is satisfied.

3. The multilayer electronic component of claim 1, wherein ec satisfies 0.924≤ec.

4. The multilayer electronic component of claim 1, wherein td satisfies 450 nm≤td≤600 nm.

5. The multilayer electronic component of claim 1, wherein the satisfies 370 nm≤te≤550 nm.

6. The multilayer electronic component of claim 1, wherein 0.400≤T/W is satisfied.

7. The multilayer electronic component of claim 1, wherein W satisfies 0.30 mm≤W≤0.75 mm.

8. The multilayer electronic component of claim 1, wherein, when a size in the second direction of the multilayer electronic component is denoted by L, L satisfies 0.80 mm≤L≤1.25 mm.

9. The multilayer electronic component of claim 1, comprising:
a side margin portion disposed on the fifth and sixth surfaces,
wherein the side margin portion is disposed to cover an end portion of the internal electrodes extending to the fifth and sixth surfaces.

10. The multilayer electronic component of claim 1, wherein
the body includes a capacitance formation portion including the dielectric layer and the internal electrodes, and first and second cover portions disposed on a first surface of the capacitance formation portion and a second surface of the capacitance formation portion, respectively, the first and second surfaces of the capacitance formation portion opposes each other in the first direction, and
when an average value of electrode connectivity measured in a central region in the first direction of the capacitance formation portion is denoted by ec1, an average value of electrode connectivity measured in a first region of the capacitance formation portion adjacent to the first cover portion, is denoted by ec2, and an average value of electrode connectivity measured in a second region of the capacitance formation portion adjacent to the second cover portion, is denoted by ec3, ec is (ec1+ec2+ec3)/3.

11. The multilayer electronic component of claim 10, wherein
when an average thickness of the dielectric layer measured in the central region is denoted by td1, an average thickness of the dielectric layer measured in the first region is denoted by td2, and an average thickness of the dielectric layer measured in the second region is denoted by td3, and
an average thickness of the internal electrode measured in the central region is denoted by te1, an average thickness of the internal electrode measured in the first region is denoted by te2, and an average thickness of the internal electrode measured in the second region is denoted by te3,
$$td is ( td 1 + td 2 + td 3 ) / 3 , and te is ( te 1 + te 2 + te 3 ) / 3.$$

12. The multilayer electronic component of claim 1, wherein the multilayer electronic component has a capacitance of 4 μF or more and 22 μF or less.

13. The multilayer electronic component of claim 1, wherein the multilayer electronic component has a size of 1005.
